(19) United States
(12) Patent Application Publication
(10) Pub. No.: US 2020/0302030 A1
(43) Pub. Date: Sep. 24, 2020

(54) METHODS AND SYSTEMS FOR TRAVEL BASED DRM

(71) Applicant: ROK Mobile International Ltd., Pacific Palisades, CA (US)

(72) Inventor: Jonathan KENDRICK, Pacific Palisades, CA (US)

(21) Appl. No.: 16/357,828

(22) Filed: Mar. 19, 2019

(51) Int. Cl. G06F 21/10; G06Q 30/06

(52) U.S. Cl. CPC G06F 21/10; G06F 2221/0704; G06Q 30/0645

(57) ABSTRACT

The present disclosure relates to travel based DRM. A content item may be restricted from being consumed unless certain travel restrictions are satisfied.

### BACKGROUND

Digital Rights Management (DRM) aids in protecting and securely delivering content for use on a computer, portable device, or network device. Content owners lock their content with a key such that when a user acquires the locked content it cannot be used without the user acquiring the key. To obtain the key, the user obtains a license from the licensing authority and stores the license on their device. Once the key is obtained, the content may be accessed on the users device according to the rule or rights that are specified in the license. Licenses include additional restrictions on rights including items such as: start times and dates, duration, and number of times a right can be exercised. For instance, the rights in a license may allow the consumer to access the content on a specific computer and copy the content to a portable device. There are, however, no known systems to implement and enforce travel based restrictions on access to content. These and other shortcomings are addressed herein.

### SUMMARY

It is to be understood that both the following general description and the following detailed description are exemplary and explanatory only and are not restrictive. The present disclosure relates to travel based Digital Rights Management (DRM) on mobile devices.

A method is described comprising receiving travel data associated with a mobile device, determining, based on the travel data, a travel parameter, and enabling, based on the travel parameter, access to a content item on the mobile device.

A method is described comprising presenting an option to rent a digital content item, wherein the option comprises a travel restriction, receiving, based on the option, a request to rent the content item, receiving an indication of one or more parameters associated with the travel restriction, generating, based on the one or more parameters, a digital rights object associated with the digital content item, and causing transmission of the digital content item and the digital rights object to a mobile device.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a travel based DRM system;

FIG. 2 illustrates rights object;

FIG. 3 depicts modes of travel for a mobile device;

FIG. 4 shows a user interface of an application configured to operate with a travel based DRM system;

FIG. 5 illustrates a travel based DRM system;

FIG. 6 is a flowchart illustrating an example method;

FIG. 7 is a flowchart illustrating an example method; and

FIG. 8 is an example operating environment.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for providing sensor-based digital rights management (DRM).

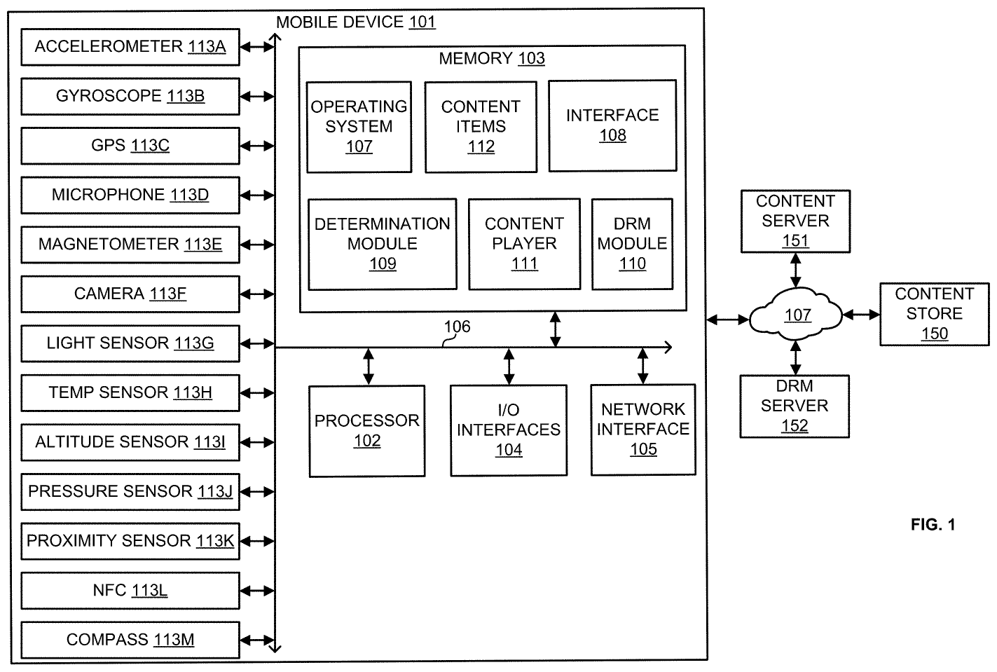

An exemplary computer system is shown as a block diagram in FIG. 1 which is a high-level diagram illustrating an exemplary configuration of a travel based Digital Rights Management (DRM) system 100. In one arrangement, A mobile device 101 can be a portable computing device such as a mobile phone, smartphone, or PDA. In other arrangements, mobile device 101 can be a tablet computer, a laptop computer, a personal computer, or an in-vehicle computer (e.g., ECU/OBD) though it should be understood that mobile device 101 of the DRM system 100 can be practically any computing device capable of embodying the systems and/or methods described herein.

The mobile device 101 of the DRM system 100 includes a processor 102, memory system 103, input/output (I/O) interfaces 104, and network interfaces 105. These components (along with other components of the mobile device 101) are communicatively coupled via a local interface 106. The local interface 106 can be, for example but not limited to, one or more buses or other wired or wireless connections, as is known in the art. The local interface 106 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 102 can be a hardware device for executing software, particularly that stored in memory system 103. The processor 102 can be any custom made or commercially available processor, a central processing unit (CPU), an auxiliary processor among several processors associated with the mobile device 101, a semiconductor-based microprocessor (in the form of a microchip or chip set), or generally any device for executing software instructions. The processor 102 can be a number of processors, a multi-processor core, or some other type of processor, depending on the particular implementation. Further, the processor 102 can be implemented using a number of heterogeneous processor systems in which a main processor is present with secondary processors on a single chip. As another illustrative example, processor 102 can be a symmetric multi-processor system containing multiple processors of the same type. When the mobile device 101 is in operation, the processor 102 can be configured to execute software stored within the memory system 103, to communicate data to and from the memory system 103, and to generally control operations of the mobile device 101 pursuant to the software.

The I/O interfaces 104 can be used to receive user input from and/or for providing system output to one or more devices or components. User input can be provided via, for example, a keyboard and/or a mouse. System output can be provided via a display device and a printer (not shown). I/O interfaces 104 can include, for example, a serial port, a parallel port, a Small Computer System Interface (SCSI), an IR interface, an RF interface, and/or a universal serial bus (USB) interface.

The network interface 105 can be any interface that enables communication between the mobile device 101 and external devices, machines and/or elements. The network interface 105 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, or any other such interfaces for connecting mobile device 101 to other computing devices and/or communication networks such as the Internet. Such connections can include a wired connection or a wireless connection (e.g. 802.11) though it should be understood that the network interface 105 can be practically any interface that enables communication. The network interface 105 may include address, control, and/or data connections to enable appropriate communications on a network 107.

In certain arrangements, one or more external databases and/or servers such as a content store server 150, a content server 151, and a DRM server 152, may also be in communication with mobile device 101. The content store server 150, the content server 151, and the DRM server 152 may be a computing and/or storage device, and/or a plurality of computing and/or storage devices, that contain(s) data, such as software applications and/or content items downloadable by the mobile device 101.

The memory system 103 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 103 may incorporate electronic, magnetic, optical, and/or other types of storage media. Note that the memory system 103 can have a distributed architecture, where various components are situated remote from one another, but can be accessed by the processor 102. The memory system 103 can be fixed or removable. The memory system 103 can take various forms, depending on the particular implementation. For example, the memory system 103 can contain one or more components or devices. For example, the memory system 103 can be a hard drive, a flash memory, a rewritable optical disk, a rewritable magnetic tape, or some combination of the above.

The software in memory system 103 may include one or more software programs, each of which comprises an ordered listing of executable instructions for implementing logical functions. In the example of FIG. 1, the software in the memory system 103 of the mobile device 101 can comprise one or more of a suitable operating system (O/S) 107, a user interface 108, a determination module 109, a DRM module 110, a content player 111, and the like. The operating system 107 essentially controls the execution of other computer programs, such as the operating system 107, the user interface 108, the determination module 109, the DRM module 110, the content player 111, and provides scheduling, input-output control, file and data management, memory management, and communication control and related services.

The memory system 103 may include data. The data can be stored in any of one or more databases. Examples of such databases comprise, DB2®, MICROSOFT® Access, MICROSOFT® SQL Server, ORACLE®, and/or MYSQL®, POSTGRESQL®. The databases can be centralized or distributed across multiple systems. The data may comprise content items 112. “Content items,” as the phrase is used herein, may also be referred to as “content,” “content data,” “content information,” “content asset,” “multimedia asset data file,” or simply “data” or “information.” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content items may be any combination of the above-described formats.

For purposes of illustration, data, application programs, and other executable program components such as the operating system 107 are illustrated herein as discrete blocks, although it is recognized that such programs and components can reside at various times in different storage components of the mobile device 101. An implementation of the user interface 108, the determination module 109, the DRM module 110, the content items 112, and/or the content player 111 can be stored on or transmitted across some form of computer readable media.

It should be understood that in some illustrative embodiments, one or more of the content items 112, the operating system (O/S) 107, the user interface 108, the determination module 109, the DRM module 110, and/or the content player 111 can be downloaded over the network 107 to the memory 103 from another device or system via the network interface 105 for use within the mobile device 101. For instance, program code and/or content items stored in a computer readable storage device in the content store server 150, the content server 151, and the DRM server 152 can be downloaded over the network 107 from the content store server 150, the content server 151, and the DRM server 152 to the mobile device 101.

Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

One or more sensors 113A-113M (generically sensors 113) can be connected to and/or in communication with the local interface 106. Generally, sensors 113 are various components, devices, and/or receivers that are preferably incorporated within and/or in communication with mobile device 101. Sensors 113 preferably detect one or more stimuli, phenomena, or any other such inputs, as will be described in greater detail below. Examples of such sensors 113 include, but are not limited to, an accelerometer 113A, a gyroscope 113B, a Global Positioning System (GPS) receiver 113C, a microphone 113D, a magnetometer 113E, a camera 113F, a light sensor 113G, a temperature sensor 113H, an altitude sensor (e.g., altimeter) 113I, a pressure sensor 113J, a proximity sensor 113K, a near-field communication (NFC) device 113L, and a compass 113M. As will be described in greater detail below, the mobile device 101 can receive one or more inputs from one or more sensors 113 in order to determine a status of the mobile device 101.

In operation, the DRM module 110 is configured to grant or deny access to one or more of the content items 112 using one or more tokens and/or keys. The content player 111 may be configured to cause output of one or more of the content items 112 in the event the DRM module 110 determines that the mobile device 101 and/or a user of the mobile device 101 is authorized to view the one or more content items 112. The DRM module 110 may employ various DRM schemes to enforce digital rights. Digital rights are separate from content items 112 and both digital rights and content items 112 are required to view content items 112. It is noted that digital rights may be embedded in the content items 112. Content items 112 may be downloaded from the content server 151 but may not be played if the corresponding digital rights generated by the DRM server 152 are not present or complied with. Content item 112 viewing may thus be limited by digital rights. Example digital rights include, but are not limited to, play count, user, user device, time of day, country, location, time zone, mode of travel, type of vehicle in which the mobile device 101 is traveling, a brand of product being consumed by a user of the mobile device 101, a company providing a service to a user of the mobile device (e.g., an airline), combinations thereof, and the like. Unless the conditions specified in the digital rights are met, a content item cannot be viewed. The DRM server 152 and/or the content server 151 may provide a key to the mobile device 101 that specifies the digital rights for a content item. The DRM module 110 can use the key to enforce the digital rights via the content player 111.

In an embodiment, the content server 151 obtains a content encryption/decryption key from the DRM server 152 and uses it to encrypt a content item for storage and later delivery in encrypted form to the mobile device 101. A media preparation profile in the content server 151 specifies an encryption type on a per content item basis. Candidate ciphers may include XOR, RC4, HC-128, AES, and along with the specification of encryption type is stored a corresponding key and a key length. Each media item has its own randomly generated key value. In the case of AES and XOR encryption, this randomly generated key value is used as the actual key for encryption/decryption, whereas for RC4 and HC-128 it is the seed key to initialize a stream cipher. AES key length is typically 128 bits. XOR key length may be 1024 bytes, and may be configurable. RC4 and HC-128 use 128 bit seed keys. The media preparation profile also specifies, on a per content item basis, the length of the byte stream which should be generated (this is the actual key used for media encryption, and the length is the same as the block length described elsewhere herein). Each content item may be transcoded in multiple formats for different target platforms, and each of the resulting transcoded content items may be encrypted with the chosen cipher and key and the encrypted files may be made available for download by the mobile device 101.

In order to use the system for downloading a content item, the mobile device 101 authenticates and registers with the DRM server 152. During this process the mobile device 101 obtains a logical device id from the DRM server 152 that is a token to represent a user of the mobile device 101, and associates this token with the specific mobile device 101 via a device “fingerprint” which is a unique identifier for the mobile device 101. The unique identification may be based on certain physical properties that may include an international mobile equipment identifier (IMEI) number, media access control (MAC) address, or certain file system properties. Each of the supported mobile devices 101 provides an Application Programming Interface (API) via which the unique identifier of that device can be obtained. Some devices have an IMEI number, some a mobile equipment identifier (MEID) number, some an electronic serial number (ESN). The iPhone has a unique device identifier (UDID).

The mobile device 101 has a built-in domain key that may be used to encrypt the exchange of the logical device ID with the DRM server 152. For enhanced security, the domain key is divided into a number of separate components which are stored so as to be difficult to locate. For example, each may be stored as an array, with elements of the array represented as strings containing an integer and some special characters which are commonly found in binary files. When the arrays are examined, it is difficult to detect where the components are located. At run-time, all arrays are processed, special characters are discarded, and elements of these arrays are converted into characters and concatenated together to produce the actual domain key.

Device registration may be carried out as follows. The DRM module 110 may generate an encrypted token containing a device id and a randomly generated long nonce. That information (device id and the random long nonce) may be encrypted with the domain key and is sent to the DRM server 152. The DRM server 152 decrypts this registration message using the same domain key, and stores an association between this user, device id, and key nonce in a database. The DRM server 152 generates a response containing a unique logical id assigned to this user. This response is encrypted with a session key constructed from domain key, device id, and the random key nonce provided by the DRM module 110, and the encrypted response is sent to the DRM module 110.

Once the DRM module 110 receives the response, the DRM module 110 decrypts the response and stores registration information into an encrypted rights file. The rights file is encrypted with the key constructed from the combination of the domain key and the device id.

Any of various content encryption schemes may be employed. The following presents several specific examples along with corresponding details regarding how encryption/decryption is carried out. In some embodiments, the encryption can be applied to portions of the file such as key frames for video in order to reduce processing load.

In one embodiment the following simple and fast symmetric (private key) encryption scheme is used. The content server 151 performs an exclusive-OR operation (XOR) between the a file containing a content item and a secret (private) key K1. In one embodiment the key K1 is 1024 bytes long. The XOR operation starts at a random position P1 within the file and continues until the end of the file. The random position P1 is chosen to be close to the beginning of the file, e.g. within the first 10% of the file. P1 can also be a predetermined fixed position, for example the very beginning of the file (location 0).

The key K1 may be chosen in a variety of ways. For example, it may be generated randomly. Alternatively, it may be generated by first choosing another random position P2 (not shown) within the same file, and selecting 1024 bytes from the media file starting at position P2. If there are not 1024 bytes remaining between P2 and the end of the file, then 1024 bytes are selected starting at position P2-1024+1. As noted, the key length may be other than 1024 bytes, and may be configurable.

The content server 151 stores P1 and P2 in a database for each media file. In addition, the content server 151 associates an expiration time with the encryption keys, stores the expiration time in the database, and re-encrypts content with new keys upon key expiration.

In an embodiment, RC4-Drop(n) may be used. RC4-drop(n) is a stream-cipher algorithm generally known to those skilled in the art. It includes the dropping of the first 3072 bytes from each generated keystream. Also, RC4 does not have a formal notion of an initialization vector (IV). Instead, a checksum is computed on a concatenated key and an arbitrarily chosen initialization value, and the checksum is used as the key.

In one embodiment of stream cipher encoding, the entire media file is divided into smaller blocks of a selected block size. With a stream cipher, one can generate an infinitely-long stream of bytes. Theoretically, if a content item (e.g., movie) were to be played only from start to finish, without rewinding or fast-forwarding (i.e. without scrubbing), a stream cipher could be used on the streaming media without specialization. However, since the user may scrub during playback, decryption requires a modification to the stream cipher. The media is divided into fixed-size blocks and a new stream of key bytes is generated for each block by using the same seed key and a different IV. The IV in this case can be just the sequential block number, starting from 0. In one embodiment the blocks can have length 32 k, but the block length can be different in other embodiments and may be configurable.

In an embodiment, HC-128 may be used. HC-128 is another well-known stream cipher whose block size can be adapted as described above. Also, in addition to block size, both RC4 and HC-128 can take into account a segment number for live streaming and for video on demand (VOD). The entire long-form content is represented as many segments, and each segment is then divided into multiple blocks from the encryption/decryption point of view.

In an embodiment, AES may be used. The same approach to block sizing may be taken for AES unless of course in some embodiments the decryption is done in hardware. It may be desirable to use the same form of AES encryption supported by iPhone® and iPad®, which is AES bit with Cipher-Block-Chaining (CBC mode). Each segment is encrypted individually, and the same key is used across all segments, but each segment has its own initialization vector which is the sequence number of the segment.

In an embodiment, the mobile device 101 may communicate with the DRM server 152 and/or the content server 151 to obtain a rights object (RO) to use in downloading, streaming, and/or playing content. The user registers with a content provider using, in one embodiment, OpenID technology and obtains a user token which uniquely identifies that user. Before the user can play a given content item, the user must obtain the decryption key. The DRM module 110 running on the mobile device 101 contacts the DRM server 152 and provides three items: <device-id, media-id, user-token>, where device-id is a unique identifier specific to that particular mobile device, media-id is a unique identifier specific to the particular media content the user wants to play, and user-token is the unique user identifier. Device id could be the unique address of the mobile device, or it may be one of the types of device identifiers discussed above.

The DRM server 152 receives the request for the RO from the mobile device 101, containing <device-id, media-id, user-token>. The DRM server 152 validates the user-token using OpenID technology and also validates that media-id is correct and has not expired. It then generates the requested RO, which contains a key value K1 for decrypting the desired content item, one or more values representative of one or more digital rights, and a media license expiration time. Even though communications between the mobile device 101 and the DRM server 152 is carried over a secure connection (SSL), the DRM server 152 may optionally encrypt the RO so that encrypted RO can be safely stored on the mobile device 101.

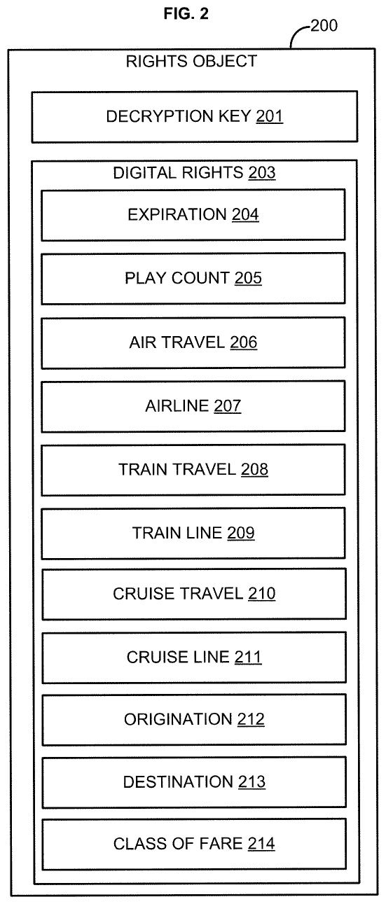

FIG. 2 shows an example rights object 200. The rights object 200 may comprise a decryption key 201 and digital rights 202. The decryption key 201 may be used by the DRM module 110 to decrypt a content item 112 for playing via the content player 111. However, the DRM module will confirm that the digital rights 202 are in compliance. The digital rights 202 may comprise an expiration 204, a play count 205, an air travel restriction 206, an airline restriction 207, a train travel restriction 208, a train line restriction 209, a cruise travel restriction 210, a cruise line restriction 211, an origination 212, a destination 213, a class of fare 214, and the like. Any number and combination of digital rights 202 are contemplated. For example, an air travel restriction with no airline restriction, a train travel restriction, a traveling restriction, a hotel restriction, and the like. The expiration 204 may specify a date and/or time after which the content item 112 associated with the RO 200 may no longer be viewed on the mobile device 101. The play count 205 may specify a number of times the content item 112 associated with the RO 200 may be viewed before requiring an a new rights object for further viewing. The air travel restriction 206 may specify that the content item 112 associated with the RO 200 may be viewed only if the mobile device 101 is currently traveling in an aircraft. The airline restriction 207 may specify that the content item 112 associated with the RO 200 may be viewed only if the mobile device 101 is currently traveling in an aircraft associated with a specific airline (e.g., Delta). The train travel restriction 208 may specify that the content item 112 associated with the RO 200 may be viewed only if the mobile device 101 is currently traveling in an train. The train line restriction 209 may specify that the content item 112 associated with the RO 200 may be viewed only if the mobile device 101 is currently traveling in a train associated with a specific train line (e.g., Amtrak). The cruise travel restriction 210 may specify that the content item 112 associated with the RO 200 may be viewed only if the mobile device 101 is currently traveling on an ocean cruise ship. The cruise line restriction 211 may specify that the content item 112 associated with the RO 200 may be viewed only if the mobile device 101 is currently traveling on an ocean cruise ship associated with a specific cruise line (e.g., Carnival). The origination restriction 212 may specify that the content item 112 associated with the RO 200 may be viewed only if the mobile device 101 is traveling (e.g., via a specific mode of transportation, a specific provider, or any) and departed from a specific origination location. The destination restriction 213 may specify that the content item 112 associated with the RO 200 may be viewed only if the mobile device 101 is traveling (e.g., via a specific mode of transportation, a specific provider, or any) and is destined for a specific destination location. The class of fare restriction 214 may specify that the content item 112 associated with the RO 200 may be viewed only if a user of the mobile device 101 is traveling (e.g., via a specific mode of transportation, a specific provider, or any) and has a certain level of fare, such as coach, business class, first class, and the like.

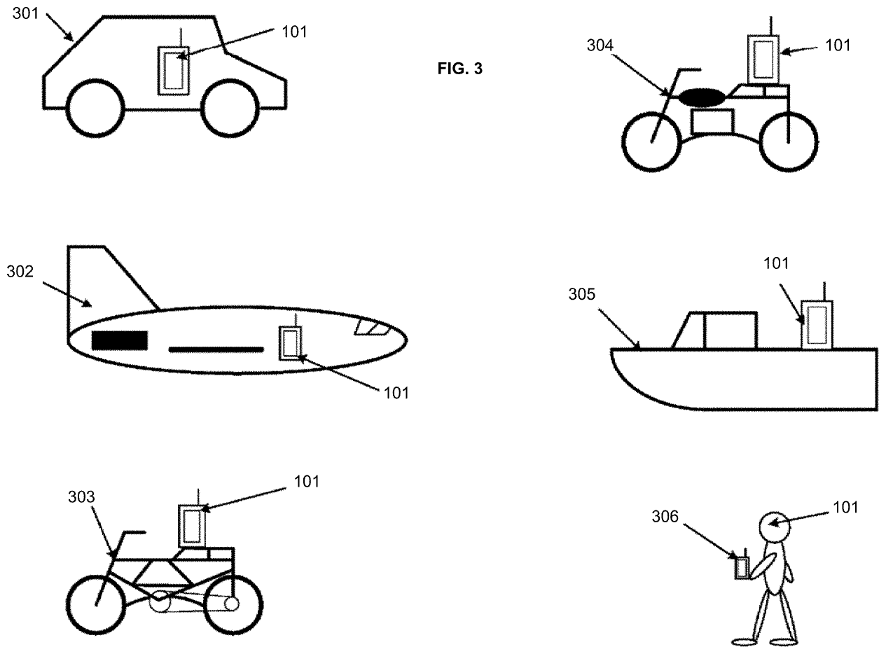

FIG. 3 shows various transportation modes (e.g., car 301, airplane 302, bicycle 303, motorcycle 304, boat 305, and pedestrian 306) each having the mobile device 101. In an embodiment, the digital rights 202 may specify that the mobile device 101 must be traveling via a specific mode of transportation in order for a content item 112 to be viewed. Accordingly, the determination module 109 may be configured to determine which mode of transportation the mobile device 101 is currently engaged.

Returning to FIG. 1, in order to enforce certain digital rights 202 the DRM module 110 must be able to ascertain if the digital rights 202 are met. The determination module 109 can make one or more determinations relevant to the digital rights 202 and provide those determinations (e.g., indications, information, data, etc) to the DRM module 110 for use in determining if the digital rights 202 have been satisfied.

In an embodiment, the determination module 109 may receive information from one or more other software applications either installed on the mobile device 101 or in communication with the mobile device 101. The determination module 109 may utilize an Application Programming Interface (API) to interface with one or more other software applications either installed on the mobile device 101 or in communication with the mobile device 101. The determination module 109 may utilize an API to obtain information from a travel application associated with a form of travel, such as an airline application, a train application, a cruise ship application, a hotel application, and the like. The determination module 109 may receive information from the travel application indicative of a date of travel, an origination point, a destination point, a time of travel, a mode of travel, and the like. The determination module 109 may provide such information to the DRM module 110. The DRM module 110 may utilize such information to confirm that one or more of the digital rights 203 are satisfied. For example, the determination module 109 may receive information via an airline application that a user of the mobile device 101 has booked a flight on Delta Airlines from Atlanta, Ga. (ATL) to Philadelphia, Pa. (PHL) on Mar. 31, 2019, departing at 1:00 pm Eastern and returning on Apr. 1, 2019, departing at 3:30 pm. Should any of the content items 112 have a DO 200 with digital rights 202 specifying that the content item 112 may only be viewed if the mobile device 101 is traveling in an airplane, then the DRM module 110 will permit viewing of the content item in accordance with the travel details received from the airline application. Similarly, if the DO 200 contains digital rights 202 specifying that the airline must be Delta Airlines, then the DRM module 110 will permit viewing of the content item in accordance with the travel details received from the airline application (e.g., only on the dates and during the times the flight is booked). If however, the DO 200 contains digital rights 202 specifying that the airline must be United Airlines, then the content item 112 will not be made available for viewing.

In one embodiment, the determination module 109 may determine information useful for the DRM module 110 to determine if digital rights 202 are met based upon one or more types of communications being serviced by the network interface 105 of the mobile device 101. For example, cellular service is not available in airplanes or remote boating areas. In an embodiment, an SSID of a wireless network to which the mobile device 101 is connected may be used to determine a location of the mobile device 101. For example, if the network interface 105 is in communication with a wireless network named “DeltaWiFi,” then the determination module 109 may determine that the mobile device 101 is traveling via airplane, and specifically with Delta Airlines, and provide this information to the DRM module 110.

In an embodiment, one or more of the sensors 113 may communicate information to the determination module 109. The determination module 109 may analyze the information and provide a result of the analysis to the DRM module 110. The DRM module 110 may use the information received from the determination module 109 to ascertain if the digital rights 202 are met.

In an embodiment, the accelerometer 113A may contain one or more accelerometers that sense and measure acceleration in up to 3 axes and that is operable to produce accelerometer output. The determination module 109 may receive accelerometer output and compare the accelerometer output to a plurality of acceleration signatures. An acceleration signature can be associated with a specific mode of transportation. The plurality of acceleration signatures can comprise pedestrian motion, bicycle motion, motorcycle motion, automobile motion, train motion, boat motion, airplane motion, and the like. The acceleration signature can comprise a periodic acceleration component and an acceleration magnitude component. For example, an acceleration magnitude differs with various acceleration magnitudes or vibration periods, such as a walking vibration period, car vibration period, boat vibration period, train vibration period, airplane vibration period, and the like. Once the accelerometer output is matched to an acceleration signature, the determination module 109 can provide an indication to the DRM module 110. The DRM module 110, based on the indication, can permit or deny viewing of the content item 112. For example, if the accelerometer output matches an acceleration signature of an airplane, the DRM module 110 can determine that the air travel restriction 206 digital right is satisfied and permit the content player 111 to output the content item 112.

In an embodiment, the GPS 113C may be used to determine a location of the mobile device 101. Any location related digital rights may be determined to be satisfied or not satisfied based on information received from the GPS 113C. The DRM module 110 may receive the location of the mobile device 101 compare the location of the mobile device 101 to a location specified in the DO 200 and either permit or deny viewing of a content item 112. In one embodiment, the determination module 109 may receive the location of the mobile device 101 and determine that the mobile device 101 is over water, which would indicate the mobile device 101 could be in a boat or airplane, but not typically in a car or with a pedestrian. In one embodiment, the determination module 109 may determine, via the GPS 113C and/or the altitude sensor (e.g., altimeter) 113I, that the mobile device 101 is at or above a certain altitude (e.g., 3,000 feet above sea level), indicative of traveling in an airplane. The determination module 109 may provide indications of the location to the DRM module 110 for use in determining if a digital right 202 has been met.

The microphone 113D may capture audio information that may be compared by the DRM module 110 to audio signatures. Airplanes, boats, cars, and pedestrians, for example may be exposed to unique surrounding noise, which may be used to generate an audio signature. The DRM module 110 may compare audio information received from the microphone 113D to a plurality of audio signatures and, based on identifying a matching audio signature, determine whether the mobile device 101 is traveling in a specific mode of transport. For example, if the audio information matches an audio signature of an airplane, the DRM module 110 can determine that the air travel restriction 206 digital right is satisfied and permit the content player 111 to output the content item 112.

In an embodiment, the determination module 109 may determine that various orientations and/or sudden changes in orientation perceived by the gyroscope 113B (preferably, in certain scenarios, in combination with one or more inputs from various other sensors 113 such as the accelerometer 113A, the GPS 113C, and/or the magnetometer 113E) can indicate that mobile device 101 is being operated in a handheld state by a user. By way of further example, the determination module 109 may determine that a relatively constant pattern of inputs from accelerometer 113A and/or gyroscope 113B can indicate that mobile device 101 is positioned in a relatively stable manner, thus indicating that it is being operated in a non-handheld state. The determination module 109 can provide such an indication to the DRM module 110 for use in determining if a digital right 202 has been met.

In an embodiment, the camera 113F may be used to take an image, or place an object within a field of view of the camera 113F, and the determination module may perform image and/or object recognition to determine that the mobile device 101 is at a certain location (e.g., at a specific airport, on a specific airline, on a specific cruise line, on a specific train line, etc . . . ). The camera 113F may scan a QR code placed on material specific to a location. For example, the camera 113F may be used to scan a QR code placed at a gate of an airport/port/train station, in a magazine specific to an airline/cruise line/train line, and the like. By way of further example, the user of the mobile device 101 may be informed that the user will be able to view a content item 112 if the user scans an image (rather than a QR code) of the airplane, train, ship, gate, magazine page, etc . . . For example, the determination module 109 can thus determine that the mobile device 101 is in a Delta Airlines airplane if the camera 113F is used to scan a certain page or find a QR code located in a copy of the Skymall magazine.

The various other sensors 113 can provide information to the determination module 109 for analysis. The information determined by the determination module 109 may be provided to the DRM module 110 for use in determining if a digital right 202 has been met.

Various techniques are described herein for enabling the DRM module 110 to ascertain if the digital rights 202 are met. These various techniques are not meant to be limiting, and other techniques using the sensors 113 are contemplated. The various techniques may be used alone or in combination to provide varying levels of confidence that the digital rights 202 are met. In an embodiment, the DO 202 may specify a confidence level in order for the digital rights 202 to be met. For example, confirmation from 2 or more sensors or sources of data may be required. Sensors and sources may also be assigned varying weights. For example, confirmation via GPS alone that the mobile device 101 is traveling via airplane may be sufficient, whereas determining that the mobile device 101 is connected to an airline Wi-Fi alone is insufficient.

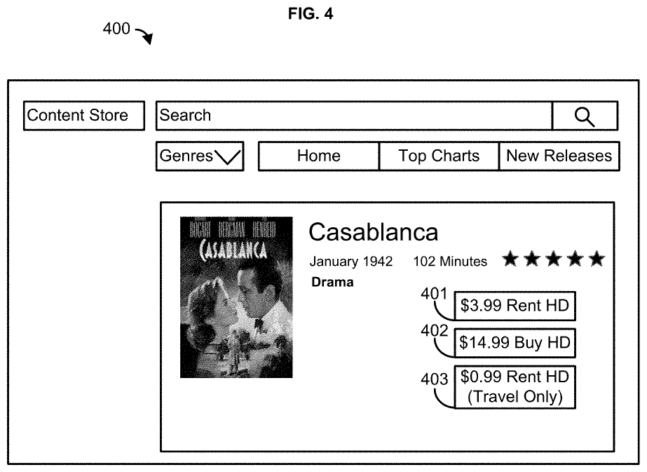

FIG. 4 illustrates an example interface 400 for enabling a user to acquire a digital right 202 to view a content item 112 with a “travel only” restriction. A user may navigate the interface 400 similar to content stores that are known in the art, such as Google Play, Apple iTunes, and the like. Upon identifying a content item 112 that the user wishes to consume, the user is presented with options include the ability to rent the content item 401, buy the content item 402, or to rent the content item with a travel only restriction 403. Typically, renting the content item via 401 would provide the user with digital rights 202 to view the content item within a certain time period, on a certain device, and the like. Renting the content item via 403 would provide the user with digital rights 202 to view the content item within a certain time period, on a certain device, and an additional travel restriction. The travel restriction may be as described with regard to FIG. 2, such as a type of travel, a specific travel provider, and the like. In exchange for the more restrictive digital rights, the user may pay less than the less restrictive option. Thus, enticing a user to rent or purchase a content item that they user might not ordinarily rent or purchase.

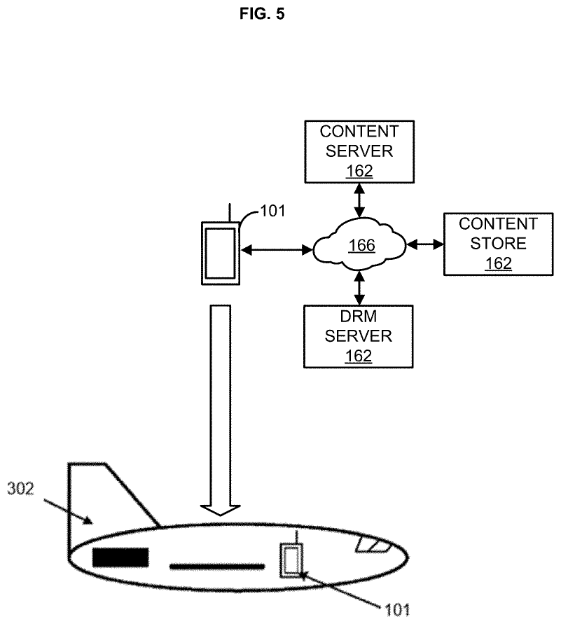

FIG. 5 shows an example operating environment. The mobile device 101 may communicate the content store server 162 via the interface 400. Upon renting a content item 112 with a travel restriction (such as an airplane travel restriction), the content store server 162 may coordinate with the DRM server 152 and/or the content server 151 to generate a rights object (RO), such as the RO 200, to transmit to the mobile device 101. Generation and use of the RO 200 is described in more detail with regard to FIG. 1. The mobile device 101 may then use the RO 200 to download the content item 112 from the content server 162. The mobile device 101 will be unable to play the content item 112 until the determination module 109 on the mobile device 101 provides an indication to the DRM module 110 on the mobile device 101, that the mobile device 101 is presently traveling in an airplane (such as airplane 302). The determination module 109 may make such a determination based on any of the various sensors 113 alone, or in combination, based on data from other software applications, based on communications with local wireless networks, and the like. Once the DRM module 110 has received a satisfactory indication that the mobile device 101 is traveling in an airplane, the DRM module 110 will permit the content player 111 to output the content item. Upon the determination module 109 determining that the mobile device 101 is no longer traveling in an airplane, the determination module 109 can provide an indication to the DRM module 110. The DRM module 110 will discontinue permitting access to the content item 112.

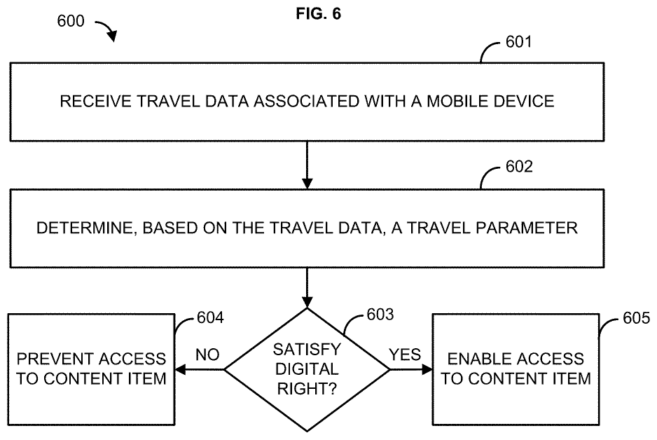

Turning now to FIG. 6, a flow diagram is described showing a method 600 for travel based DRM comprising receiving travel data associated with a mobile device at 601. The method 600 can comprise determining, based on the travel data, a travel parameter at 602.

The travel data can comprise accelerometer data and determining, based on the travel data, the travel parameter can comprise determining, based on the accelerometer data, an acceleration signature of a plurality of acceleration signatures and determining a mode of travel associated with the acceleration signature.

The travel data can comprise itinerary data and determining based on the travel data, the travel parameter can comprise determining, based on the itinerary data, one or more of a travel provider, a departure date, a departure time, an origination location, an arrival date, an arrival time, or a destination location and determining, based on one or more of the travel provider, the departure date, the departure time, the arrival data, or he arrival time, the travel parameter.

The travel data can comprise an image and determining based on the travel data, the travel parameter can comprise determining a travel provider associated with the image and determining, based on the travel provider, the travel parameter.

The travel data can comprise a network identifier and determining based on the travel data, the travel parameter can comprise determining a travel provider associated with the network identifier and determining, based on the travel provider, the travel parameter.

The travel data can comprise GPS data and determining, based on the travel data, the travel parameter can comprise determining, based on the GPS data, one or more of an altitude, a speed, or a location of the mobile device and determining, based on one or more of the altitude, the speed, or the location, the travel parameter.

The travel data can comprise altimeter data and determining, based on the travel data, the travel parameter can comprise determining, based on the altimeter data, an altitude of the mobile device and determining, based on the altitude, the travel parameter.

At 603 it can be determined whether the travel parameter satisfies a digital right associated with the content item. The digital right associated with the content item can comprise one or more of an air travel restriction, an airline restriction, a train travel restriction, a train line restriction, a cruise travel restriction, a cruise line restriction, an origination location restriction, a destination location restriction, or a class of fare restriction. For example, the digital right may specify that the mobile device must be traveling in an airplane in order for access to the content item to be permitted. The travel parameter may be configured to indicate a mode of travel (e.g., car, train, airplane, ship). If the travel parameter does not satisfy the digital right, access to the content item can be prevented at 604. If the travel parameter does satisfy the digital right, access to the content item can be enabled at 604.

The method 600 can further comprise sending a request for the content item and receiving the content item and a rights object associated with the content item. The rights object can prevent the mobile device from displaying the content item unless the digital right associated with the content item is satisfied.

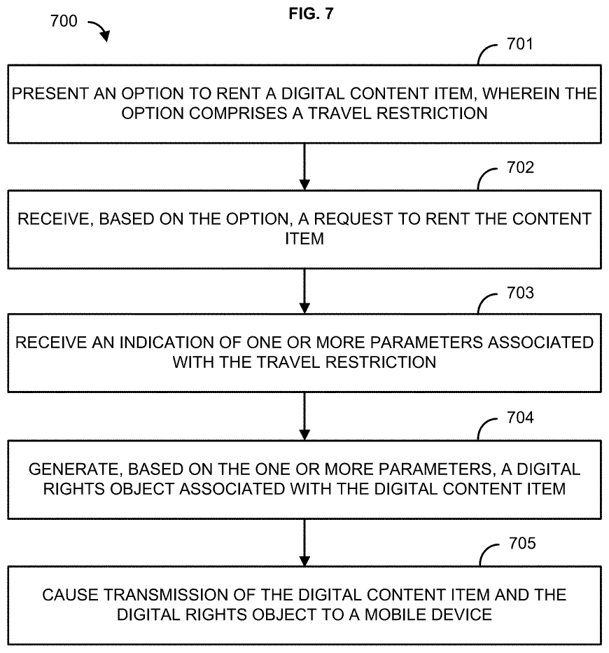

Turning now to FIG. 7, a flow diagram is described showing a method 700 for travel based DRM comprising presenting an option to rent a digital content item, wherein the option comprises a travel restriction at 701. The travel restriction comprises one or more of an air travel restriction, an airline restriction, a train travel restriction, a train line restriction, a cruise travel restriction, a cruise line restriction, an origination location restriction, a destination location restriction, or a class of fare restriction.

In an embodiment, a travel provider may sponsor a content item. Sponsoring a content item may result in the price of the content item being reduced for a user because the travel provider is subsidizing a portion of the rental expense. The travel provider may specify the travel restrictions, including, for example, requiring that the mobile device travel with the travel provider in order to view the content item at the reduced price.

The method 700 can comprise receiving, based on the option, a request to rent the content item at 702. The user may select the option to download and rent the content item at the reduced price, thereby accepting the travel restriction as a prerequisite to being able to view the content item.

The method 700 can comprise receiving an indication of one or more parameters associated with the travel restriction at 703. The one or more parameters comprises one or more of a selected mode of travel, a selected travel provider, a departure date, a departure time, an origination location, an arrival date, an arrival time, or a destination location. In an embodiment, the user may be provided the option to indicate how the user will be traveling in order to satisfy the travel restriction. If the user does not indicate parameters that are likely to satisfy the travel restriction, the user may be prevented from renting the content item with the travel restriction.

The method 700 can comprise generating, based on the one or more parameters, a digital rights object associated with the digital content item at 704. The method 700 can comprise causing transmission of the digital content item and the digital rights object to a mobile device at 705.

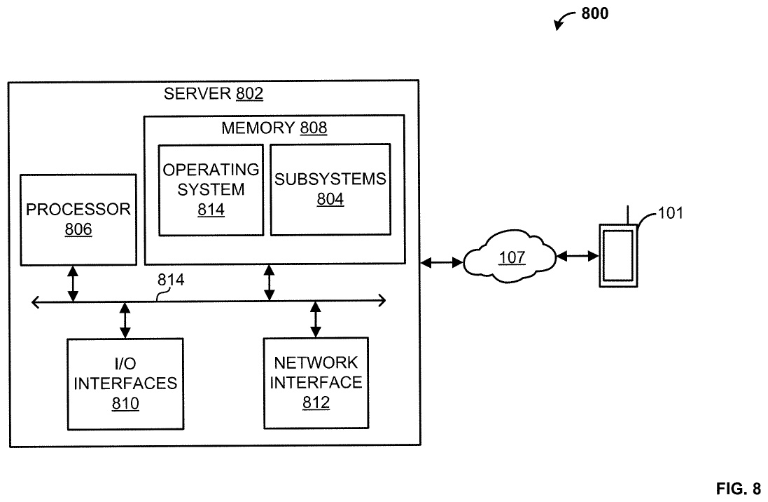

FIG. 8 is a block diagram depicting an environment 800 comprising non-limiting examples of a server 802 (e.g., the content store server 150, the content server 151, and the DRM server 152) and the mobile device 101 connected through the network 107. The server 802 can comprise one or multiple computers configured to store one or more of various subsystems 804. The various subsystems 804 may comprise one or more of a storefront subsystem, a content subsystem, and a DRM subsystem, embodied on the content store server 150, the content server 151, and the DRM server 152, respectively, for carrying out the methods described herein. Multiple mobile devices 101 can connect to the server(s) 802 through the network 107 such as, for example, the Internet or any wired or wireless connection.

The servers 802 can be a digital computer that, in terms of hardware architecture, generally includes a processor 806, memory system 808, input/output (I/O) interfaces 810, and network interfaces 812. These components are communicatively coupled via a local interface 814. The local interface 814 can be, for example but not limited to, one or more buses or other wired or wireless connections, as is known in the art. The local interface 814 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 806 can be a hardware device for executing software, particularly that stored in memory system 808. The processor 806 can be any custom made or commercially available processor, a central processing unit (CPU), an auxiliary processor among several processors associated with the server 802, a semiconductor-based microprocessor (in the form of a microchip or chip set), or generally any device for executing software instructions. When the server 802 is in operation, the processor 806 can be configured to execute software stored within the memory system 808, to communicate data to and from the memory system 808, and to generally control operations of the server 802 pursuant to the software.

The I/O interfaces 810 can be used to receive user input from and/or for providing system output to one or more devices or components. User input can be provided via, for example, a keyboard and/or a mouse. System output can be provided via a display device and a printer (not shown). I/O interfaces 81 can include, for example, a serial port, a parallel port, a Small Computer System Interface (SCSI), an IR interface, an RF interface, and/or a universal serial bus (USB) interface.

The network interface 812 can be used to transmit and receive from an external server 802 or the mobile device 101 on the network 107. The network interface 812 may include, for example, a 10 BaseT Ethernet Adaptor, a 100 BaseT Ethernet Adaptor, a LAN PHY Ethernet Adaptor, a Token Ring Adaptor, a wireless network adapter (e.g., WiFi), or any other suitable network interface device. The network interface 812 may include address, control, and/or data connections to enable appropriate communications on the network 107.

The memory system 808 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 808 may incorporate electronic, magnetic, optical, and/or other types of storage media. Note that the memory system 808 can have a distributed architecture, where various components are situated remote from one another, but can be accessed by the processor 806.

The software in memory system 808 may include one or more software programs, each of which comprises an ordered listing of executable instructions for implementing logical functions. In the example of FIG. 8, the software in the memory system 808 of the server 802 can comprise one or more of the subsystems 804 and a suitable operating system (O/S) 814. The operating system 814 essentially controls the execution of other computer programs and provides scheduling, input-output control, file and data management, memory management, and communication control and related services.

For purposes of illustration, application programs and other executable program components such as the operating system 814 are illustrated herein as discrete blocks, although it is recognized that such programs and components can reside at various times in different storage components of the server 802. An implementation of the subsystems 804 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving travel data associated with a mobile device;
determining, based on the travel data, a travel parameter; and
enabling, based on the travel parameter, access to a content item on the mobile device.

2. The method of claim 1, wherein the travel data comprises accelerometer data.

3. The method of claim 2, wherein determining, based on the travel data, the travel parameter comprises:
determining, based on the accelerometer data, an acceleration signature of a plurality of acceleration signatures; and
determining a mode of travel associated with the acceleration signature.

4. The method of claim 1, wherein the travel data comprises itinerary data.

5. The method of claim 4, wherein determining, based on the travel data, the travel parameter comprises:
determining, based on the itinerary data, one or more of a travel provider, a departure date, a departure time, an origination location, an arrival date, an arrival time, or a destination location; and
determining, based on one or more of the travel provider, the departure date, the departure time, the arrival data, or he arrival time, the travel parameter.

6. The method of claim 1, wherein the travel data comprises an image.

7. The method of claim 6, wherein determining, based on the travel data, the travel parameter comprises:
determining a travel provider associated with the image; and
determining, based on the travel provider, the travel parameter.

8. The method of claim 1, wherein the travel data comprises a network identifier.

9. The method of claim 8, wherein determining, based on the travel data, the travel parameter comprises:
determining a travel provider associated with the network identifier; and
determining, based on the travel provider, the travel parameter.

10. The method of claim 1, wherein the travel data comprises Global Positioning System (GPS) data.

11. The method of claim 10, wherein determining, based on the travel data, the travel parameter comprises:
determining, based on the GPS data, one or more of an altitude, a speed, or a location of the mobile device; and
determining, based on one or more of the altitude, the speed, or the location, the travel parameter.

12. The method of claim 1, further comprising:
sending a request for the content item; and
receiving the content item and a rights object associated with the content item.

13. The method of claim 12, wherein the rights object prevents the mobile device from displaying the content item unless a digital right associated with the content item is satisfied.

14. The method of claim 13, wherein the digital right associated with the content item comprises one or more of an air travel restriction, an airline restriction, a train travel restriction, a train line restriction, a cruise travel restriction, a cruise line restriction, an origination location restriction, a destination location restriction, or a class of fare restriction.

15. A method comprising:
presenting an option to rent a digital content item, wherein the option comprises a travel restriction;
receiving, based on the option, a request to rent the content item;
receiving an indication of one or more parameters associated with the travel restriction;
generating, based on the one or more parameters, a digital rights object associated with the digital content item; and
causing transmission of the digital content item and the digital rights object to a mobile device.

16. The method of claim 15, wherein the travel restriction comprises one or more of an air travel restriction, an airline restriction, a train travel restriction, a train line restriction, a cruise travel restriction, a cruise line restriction, an origination location restriction, a destination location restriction, or a class of fare restriction.

17. The method of claim 15, wherein the one or more parameters comprises one or more of a selected mode of travel, a selected travel provider, a departure date, a departure time, an origination location, an arrival date, an arrival time, or a destination location.

18. An apparatus, comprising:
a processor;
one or more sensors in communication with the processor; and
a determination module, configured to:
receive travel data associated with the apparatus; and
determining, based on the travel data, a travel parameter;
a digital rights management (DRM) module, configured to:
receive the travel parameter from the determination module; and
enable, based on the travel parameter, access to a content item on the apparatus.

19. The apparatus of claim 18, further comprising:
an interface, configured to:
send a request for the content item; and
receive the content item and a rights object associated with the content item.

20. The apparatus of claim 19, wherein the rights object is configured to prevent the apparatus from displaying the content item unless a digital right associated with the content item is satisfied and wherein the digital right associated with the content item comprises one or more of an air travel restriction, an airline restriction, a train travel restriction, a train line restriction, a cruise travel restriction, a cruise line restriction, an origination location restriction, a destination location restriction, or a class of fare restriction.
